(19) United States
(12) Patent Application Publication
(10) Pub. No.: US 2011/0319045 A1
(43) Pub. Date: Dec. 29, 2011

(54) LINEAR INTERFERENCE CANCELLATION RECEIVER

(76) Inventors: Wenjun Li, San Diego, CA (US); Farrokh Abrishamkar, San Diego, CA (US); Srikanth Gummadi, San Diego, CA (US)

(21) Appl. No.: 13/100,987

(22) Filed: May 4, 2011

Related U.S. Application Data
(60) Provisional application No. 61/331,493, filed on May 5, 2010.

(51) Int. Cl. H04B 1/10

(52) U.S. Cl. 455/296

(57) ABSTRACT

Interference cancellation at a user equipment includes performing channel estimation for each component of an aggregate received signal using at least one received midamble of at least one time slot. The aggregate received signal is received from at least one Node B. A combined channel is computed for each channelization code based on the channel estimation. A linear transfer function is obtained for all user equipment within a cell. This linear transfer function includes a combined channel for each channelization code. An equalization matrix is derived from the linear transfer function and then applied to the aggregate received signal to obtain the component intended for the user equipment.

### CROSS REFERENCE TO RELATED APPLICATION

This application claims the benefit of U.S. provisional patent application No. 61/331,493 filed May 5, 2010, in the names of LI et al., the disclosure of which is expressly incorporated herein by reference in its entirety.

### BACKGROUND

1. Field

Aspects of the present disclosure relate generally to wireless communication systems, and more particularly, to linear interference cancellation receivers.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the disclosure, a method for cancellation of interference at a first user equipment includes performing channel estimation for each component of an aggregate received signal using at least one received midamble of at least one time slot. The aggregate received signal is received from at least one Node B. The method also includes computing a combined channel for each channelization code based on the channel estimation and obtaining a linear transfer function for all user equipment within a cell. The linear transfer function includes the combined channel for each channelization code. The method also includes deriving an equalization matrix from the linear transfer function, and applying the equalization matrix to the aggregate received signal to obtain the component intended for the first user equipment.

In another aspect of the disclosure, a first user equipment configured for interference cancellation includes means for performing channel estimation for each component of an aggregate received signal using at least one received midamble of at least one time slot. The aggregate received signal is received from at least one Node B. The first user equipment also includes means for computing a combined channel for each channelization code based on the channel estimation, and means for obtaining a linear transfer function for all user equipment within a cell. The linear transfer function includes the combined channel for each channelization code. The first user equipment also has means for deriving an equalization matrix from the linear transfer function, and means for applying the equalization matrix to the aggregate received signal to obtain the component intended for the first user equipment.

In another aspect of the disclosure, a computer program product has a computer readable medium with program code stored thereon. The program code includes code to perform channel estimation for each component of an aggregate received signal using at least one received midamble of at least one time slot. The aggregate received signal is received from at least one Node B. The program code also includes code to compute a combined channel for each channelization code based on the channel estimation, and code to obtain a linear transfer function for all user equipments within a cell. The linear transfer function includes the combined channel for each channelization code. The program code also includes code to derive an equalization matrix from the linear transfer function, and code to apply the equalization matrix to the aggregate received signal to obtain the component intended for a first user equipment.

In another aspect of the disclosure, a first user equipment for wireless communication includes at least one processor and a memory coupled to the processor. The processor is configured to perform channel estimation for each component of an aggregate received signal using at least one received midamble of at least one time slot. The aggregate received signal is received from at least one Node B. The processor is also configured to compute a combined channel for each channelization code based on the channel estimation and to obtain a linear transfer function for all user equipment within a cell. The linear transfer function includes the combined channel for each channelization code. The processor is also configured to derive an equalization matrix from the linear transfer function, and to apply the equalization matrix to the aggregate received signal to obtain the component intended for the user equipment.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a diagram illustrating a TD-SCDMA network.

FIG. 5 is a block circuit diagram illustrating a transmitter for a TD-SCDMA system.

FIG. 6A is a block circuit diagram illustrating a data chips transmission pathway.

FIG. 6B is a block circuit diagram illustrating the equivalent channel transmission pathway.

FIG. 7 is a functional block diagram illustrating example blocks executed to implement one aspect of the present teachings.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

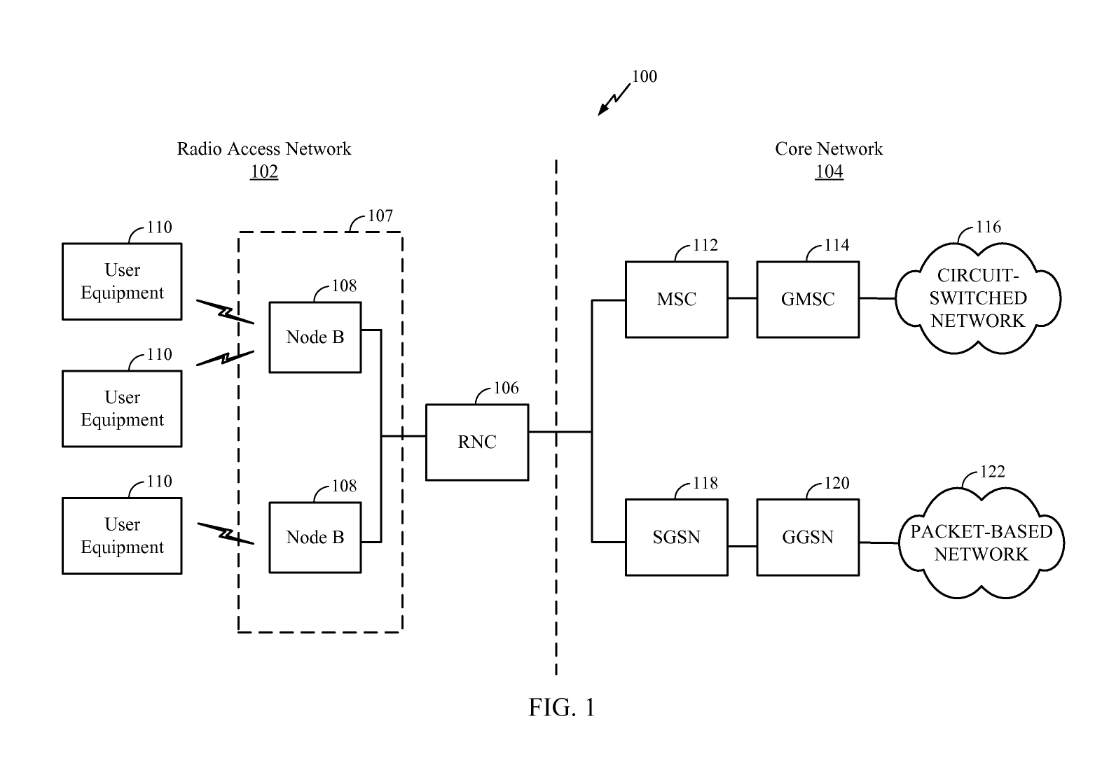

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

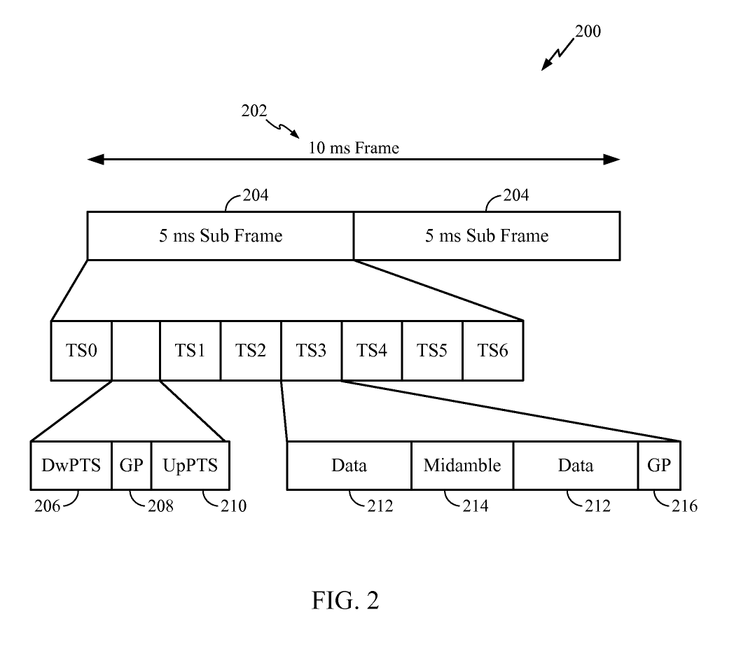

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference. The timing for each downlink time slot in TD-SCDMA is approximately 675 μs or 864 chips. Each chip corresponds to approximately 0.78 μs. The midamble utilizes 144 chips and there are approximately 704 total chips dedicated for data in the combined two data portions 212. Finally, the GP 216 utilizes 16 chips.

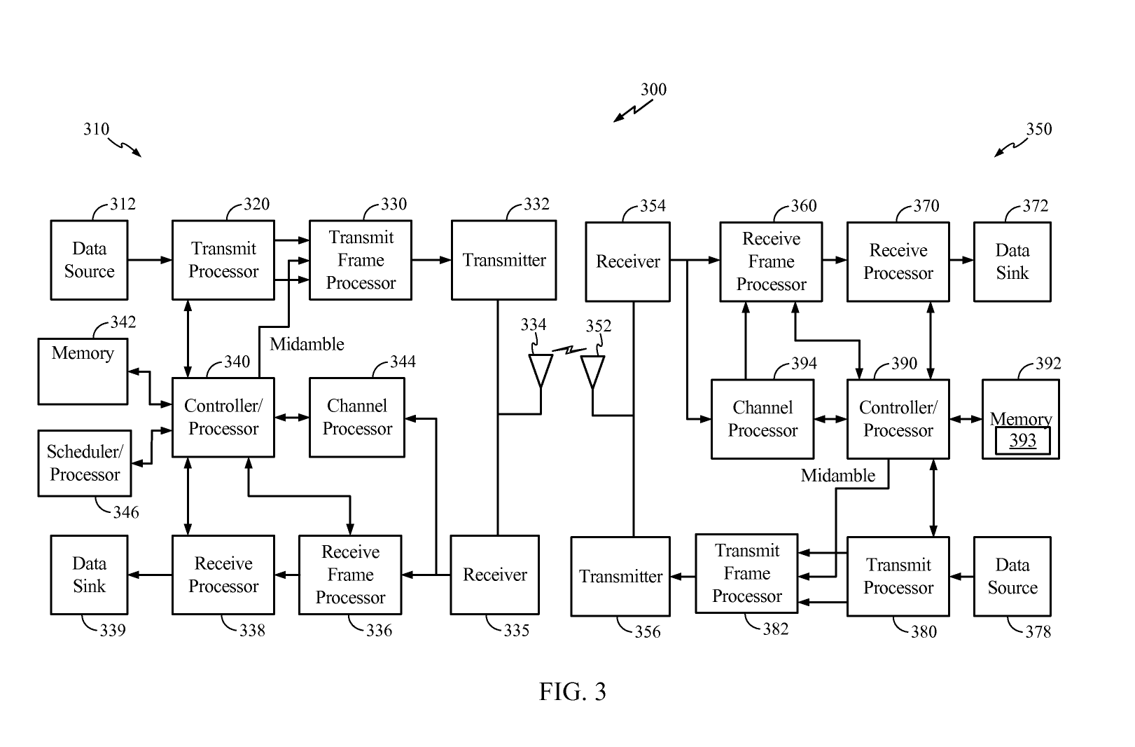

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be transmitted to the Node B 310 for use in selecting the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

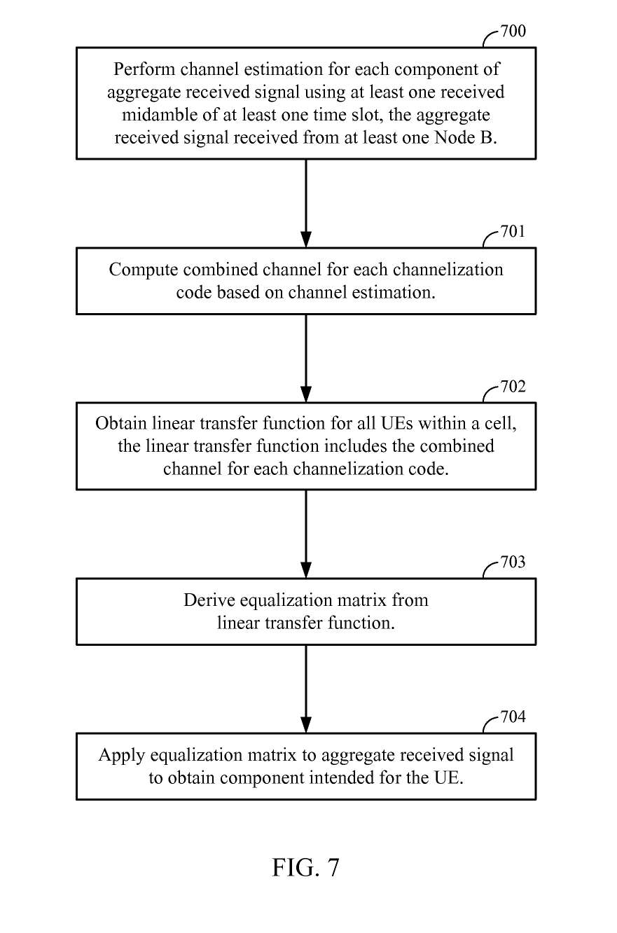

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. For example, the memory 392 of the UE 350 stores linear interference cancellation module 393. When executed by the receive processor 370, the executing linear interference cancellation module 393 configures the UE 350 to perform the interference cancellation functionality as described in the various aspects of the present teachings, such as, for example, the functional blocks described in FIG. 7. A scheduler/processor 346 at the Node B 310 may be used to allocate resources to the UEs and schedule downlink and/or uplink transmissions for the UEs.

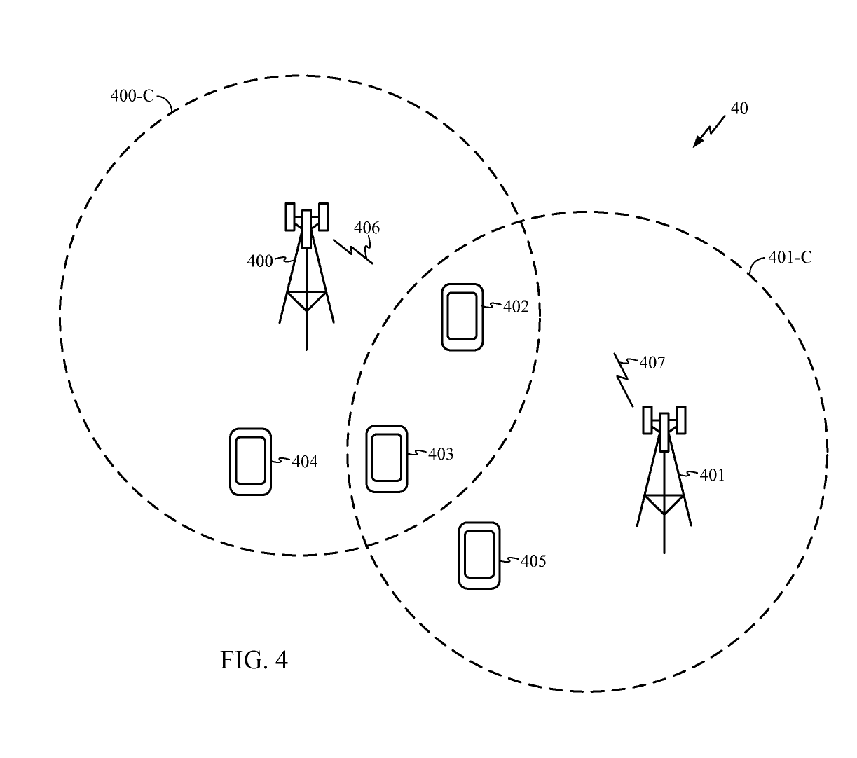

FIG. 4 is a diagram illustrating a TD-SCDMA network 40. While the TD-SCDMA network 40 may include many cells served by many different Node Bs, the illustration presented in FIG. 4, for convenience, shows only two cells 400-C and 401-C served by Node Bs 400 and 401, respectively. A number of UEs, UEs 402-405, are situated in the two cells 400-C and 401-C. In maintaining communication with the various UEs within the cells 400-C and 401-C, the Node Bs 400 and 401 transmit an aggregate signal, the aggregate signals 406 and 407, which includes signal components specifically directed or addressed to each individual UE with which communication is maintained. For example, the Node B 400 maintains communication with the UEs 402-404. Therefore, the aggregate signal 406 includes a component directed to the UE 402, another component, directed to the UE 403, and another component directed to the UE 404. Similarly, the aggregate signal 407 transmitted by the Node B 401 includes a component directed to the UE 402, another component directed to the UE 403, and another component directed to the UE 405. The presence of the signal components directed at the other UEs will provide interference to the signal component directed to the subject UE. Moreover, the aggregate signal 407 will provide interference to the component signal of the UE 403 transmitted within the aggregate signal 406 from the Node B 400. In order to accurately and efficiently extract the appropriate signal component from each of the aggregate signals 406 and 407, the interference from the competing signals and signal components will be accounted for and removed.

In order to begin accounting for the interference, the receiving UEs start with a channel estimate. Based at least in part on this estimate, the UE may differentiate the different signal components. However, to begin the estimation process, the model of the transmitted data chips is used. For a user k, where k represents the specific channelization code index for a channelization code such as a Walsh code or other orthogonal codes, the transmit data chips, uₖ(n) where n is the chip index, is represented by:

[symbol]

(1)

[symbol]

(2)

where, s is the scrambling code specific to the particular cell, N is the spreading factor, wₖ is the channelization code, βₖis the channel code multiplier for the k^{th} channelization code, dₖ is the data symbol for the k^{th} channelization code, and pₖ is product of the k^{th} channelization code multiplier, the channelization code, and the scrambling code. Considering an example with multiple transmit antennas, the total transmit data chips, tⁱ(n), for the i^{th} antenna is represented by:

[symbol]

(3)

where K is the total number of channelization codes, αₖⁱ is the beamforming weight for the k^{th} channelization code at the i^{th} transmit antenna out of Nₜ antennas, and gₖ is the gain of the k^{th} channelization code. Formula (3), therefore, represents the transmit chip signal model.

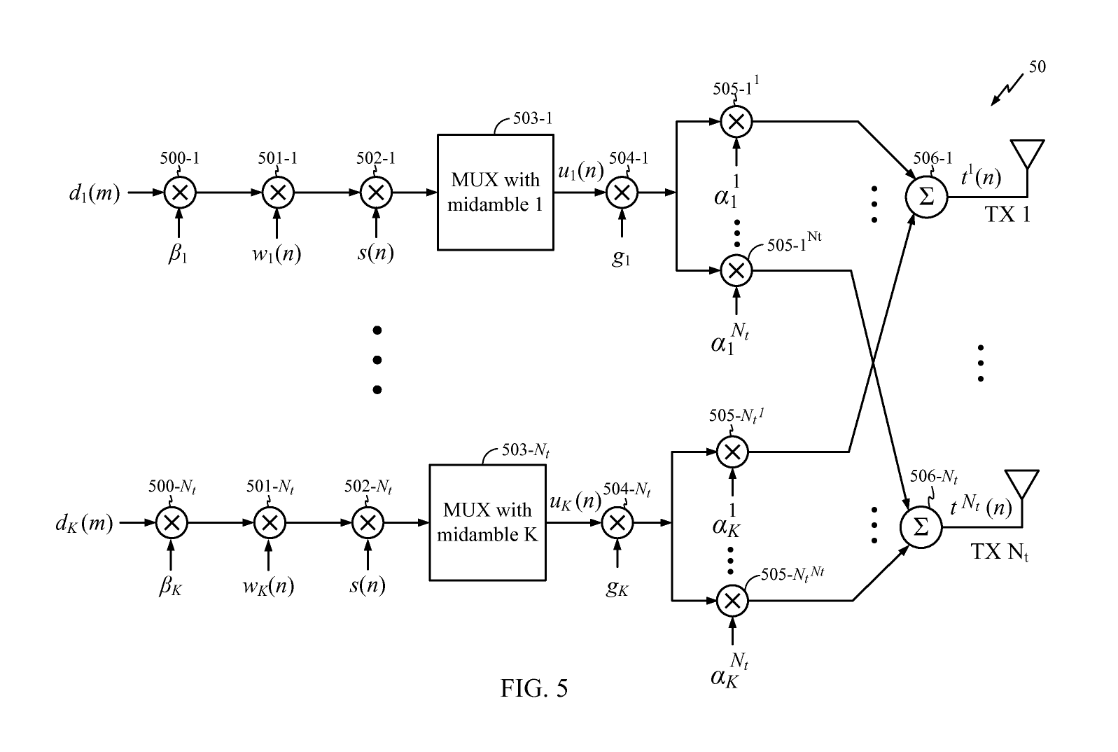

FIG. 5 is a block circuit diagram illustrating a transmitter 50 for a TD-SCDMA system. The transmitter 50 includes multiple transmit antennas TX 1-TX Nₜ for transmitting data to multiple UEs (not shown). Each set of data to be transmitted for a particular UE will be processed using its own assigned channelization code, wₖ. The data is transmitted as a set of symbols, d₁(m)-dₖ(m), where the sets are associated with each UE illustrated by the channelization code index, k. As the processing of the data symbols begins in the transmitter 50, channel code multipliers, β₁-βₖ are added to the data symbol sets at mixers 500-1-500-Nₜ. Each symbol set d₁(m)-dₖ(m) is then processed with the corresponding channelization code, w₁(n)-wₖ(n), at mixers 501-1-501-Nₜ, and then the scrambling code for the particular cell, s(n), at mixers 502-1-502-Nₜ. The processed symbol sets, d₁(m)-dₖ(m), are then multiplexed with the corresponding midamble slot at multiplexers (MUXs) 503-1-503-Nₜ into transmit chips, u₁(n)-uₖ(n).

Before the transmit chips, u₁(n)-uₖ(n), are transmitted, they are further processed with a channelization gain, g₁-gₖ, at mixers 504-1-504-Nₜ. When transmitting the data chips, the transmitter 50 will transmit the chips for each UE on each of its transmit antennas, TX 1-TX Nₜ. In doing so, each set of transmit chips will go through beamforming before being combined with the total transmit chips, t¹(n)-t^{Nt}(n). The transmit chips, u₁(n)-uₖ(n), are processed with the beamforming weights, (α¹₁-α^{Nt}₁) through (α¹_{K}-α^{Nt}_{K}), at mixers (505-1¹-505-1^{Nt}) through (505-Nₜ¹-505ₜ^{Nt}). The total transmit chips, t¹(n)-t^{Nt}(n), are then combined by combiners 506-1-506-Nₜ at each of the antennas, TX 1-TX Nₜ, before being transmitted into the atmosphere.

In order to characterize the transmitted data from the transmission point to the receiver, a model of the received signal is also used. At the receiver, the total transmit chips, t¹(n)-t^{Nt}(n), are viewed with the added components from the transmit antenna propagation channel as well as the various noise picked up during the transmission. Thus, the formula for the received chips, r(n), may be represented by:

[symbol]

(4)

where hⁱ represents the propagation channel from the i^{th} transmit antenna to the receiver, N_{AWGN} is the additive white Gaussian noise (AWGN), and v is the channel memory.

With the data chips having a representative model on the transmission side and the receiver side, an equivalent channel, \tilde{h}ₖ, may be defined by:

[symbol]

(5)

[symbol]

(6)

Where the equivalent channel of the k^{th} user, subsuming gain, beamforming, and the propagation channel, may be represented by:

[symbol]

(7)

Thus, it can be seen from equation (7) that per-code beamforming combined with propagation channel results in the formulation of an equivalent channel experienced by the individual codes or individual users.

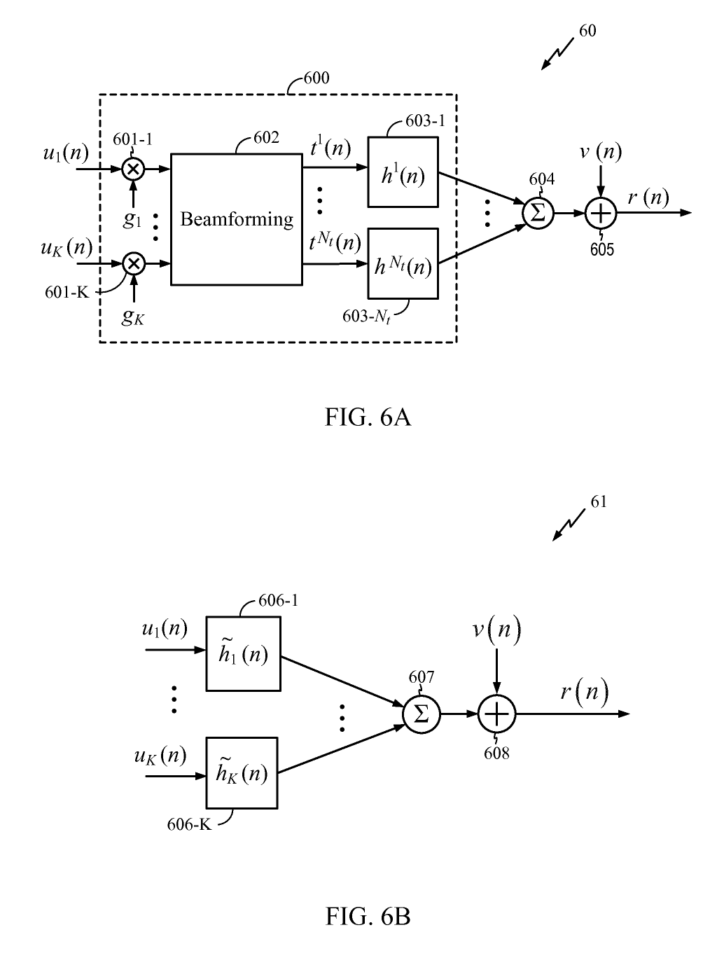

FIG. 6A is a block circuit diagram illustrating the data chips transmission pathway 60. Beginning with the transmit chips, u₁(n)-uₖ(n), the gain, g₁-gₖ, is added at mixers 601-1-601-K. The gain-processed transmit chips, u₁(n)-uₖ(n), are then subjected to a beamforming process 602 resulting in the total transmit chips, t¹(n)-t^{Nt}(n). The beamformed transmit chips, t¹(n)-t^{Nt}(n), are then packaged into each antenna's propagation channel, h¹(n)-h^{Nt}(n), and transmitted over the air. Using the received signal model from equation (4), the received chips, r(n), result from the combination of the beamformed transmit chips, t¹(n)-t^{Nt}(n), and propagation channels, h¹(n)-h^{Nt}(n), at 604 with the addition of the AWGN, N_{AWGN}, at 605.

With the derivation of the equivalent channel, \tilde{h}ₖ, the data chips transmission pathway 60 may now be represented in a much more abbreviated format. FIG. 6B is a block circuit diagram illustrating the equivalent channel transmission pathway 61. Now, the representation begins with the transmit chips, u₁(n)-uₖ(n), being packaged into the equivalent channels, \tilde{h}₁(n)-\tilde{h}ₖ(n), and transmitted over the air. Using the received chips equation (6), the received chips, r(n), result from the combination of the transmit chips, u₁(n)-uₖ(n), with the equivalent channels, \tilde{h}₁(n)-\tilde{h}ₖ(n), at 607 with the addition of the AWGN, N_{AWGN}, at 608.

In accordance with one aspect of the present teachings, interference canceling may be implemented through the use of linear multi-user detection (LMUD). The various aspects of the present teachings utilize an input-output transfer function specific to downlink TD-SCDMA standards and communications systems. Notable features that may be present in such systems include an input of user symbols, an output of the total received chips, different users being separated or distinguished by channelization codes, periodic scrambling, beamforming for each channelization code, and dispersive channels.

To start the analysis of LMUD, a single cell, single user scenario is considered first for simplicity. The channel output of the specific channelization code, k, is represented by:

[symbol]

(8)

Where pₖ represents the product of the k^{th} channelization multiplier, the channelization code, and scrambling code. When considered for the symbol time m, the channel output is represented by:

[symbol]

(9)

A combined channel, cₖ, for the k^{th} channel may be defined through a combination of the equivalent channel, \tilde{h}ₖ, and the product, pₖ, according to the formula:

[symbol]

(10)

which, when inserted into equation (9), the channel output, xₖ, becomes the transfer function for the single cell, single user operation, as represented by the formula:

[symbol]

(11)

With regard to formula (11), a channel h dispersion of N is considered. If the actual channel length is smaller, zeros may be used to pad symbols. More transmitted symbols may be accounted for if the actual channel length is longer.

Advancing the complexity of the LMUD, a single cell, multi-user scenario is considered with K users. The center and left transfer functions are represented by:

[symbol]

(12)

and

[symbol]

(13)

Therefore, the single symbol received chip vector at time m is represented by:

[symbol]

(14)

Equation (14) for the single symbol received chip vector defines the multi-user transfer function.

Having derived the single cell transfer functions for both the single and multi-user operations, a system model may be defined as a chip-symbol transfer function with a single-symbol memory with N chips. This system model is represented by:

[symbol]

(15)

Or,

[symbol]

(16)

The linear transfer function of equation (16) represents the system transfer function for the users within the cell. The linear transfer function of the system in equation (15) illustrates the use of a sliding window in defining the system from the output of the transmitter to the input of the receiver. The received chips, r[m] and r[m+1], in two symbol periods, are derived based on data symbols, d[m−1], d[m], and d[m+1], over three symbol periods.

In order to perform interference cancellation, a multi-user detection scheme is implemented to derive an equalization matrix that may be employed on the received chips, r[m] in order to cancel the interference and derive the corresponding transmitted data symbols, d[m]. In one aspect of the present teachings, a linear minimum mean squared error (LMMSE) is applied to a given set of received chips, r[m], to estimate the data symbols, d[m]. The equalization matrix is derived by computing the time-invariant covariance and cross-covariance of the received chips and data symbols. The covariance is calculated according to the formula:

[symbol]

(17)

while the cross-covariance is calculated according to the formula:

[symbol]

(18)

The LMMSE estimate may then be represented by:

[symbol]

(19)

where,

[symbol]

(20)

Therefore, after deriving the equalization matrix, W, it is applied to the received chips, r[m], in equation (19) to obtain the data symbols, d[m].

In another aspect of the present teachings, a zero-forcing estimate is used instead of the LMMSE estimate. In such an aspect, the zero-forcing estimate is represented by:

[symbol]

(21)

where,

[symbol]

(22)

Adding multiple cells to the LMUD process adds a further layer of complexity to the derivation of the equalization matrix, W. The linear system transfer function defined in equation (16) remains the same. In one aspect of the present teachings that uses LMMSE estimation for the data chips, d[m], the received chips, r[m], are represented by:

[symbol]

(23)

where, l, is the cell index, with L representing the number of cells. The formula for cross-covariance is similar to equation (18):

[symbol]

(24)

The covariance of the multi-cell instance is represented by:

[symbol]

(25)

The LMMSE estimate may then be represented by:

[symbol]

(26)

where,

[symbol]

(27)

Therefore, the number of cells does not affect the complexity of the LMUD system configured according to one aspect of the present teachings other than the covariance calculation of equation (24).

FIG. 7 is a functional block diagram illustrating example blocks executed to implement one aspect of the present teachings. In block 700, channel estimation is performed for each component of an aggregate received signal using at least one received midamble of at least one time slot. The aggregate received signal is received from at least one Node B. A combined channel is computed, in block 701, for each channelization code based on the channel estimation. A linear transfer function is obtained, block 702, for all UEs within a cell, the linear transfer function including the combined channel for each channelization code. In block 703, an equalization matrix is derived from the linear transfer function. The equalization matrix is applied to the aggregate received signal to obtain the component intended for the UE in block 704.

In one configuration, the UE 350 for wireless communication includes means for performing channel estimation for each component of an aggregate received signal using at least one received midamble of at least one time slot. The aggregate received signal is received from at least one Node B. The UE also includes means for computing a combined channel for each channelization code based on the channel estimation and means for obtaining a linear transfer function for all user equipment within a cell. The linear transfer function comprises the combined channel for each channelization code. The UE further includes means for deriving an equalization matrix from the linear transfer function and means for applying the equalization matrix to the aggregate received signal to obtain the component intended for the user equipment. In one aspect, the aforementioned means may be the antennas 352, the receiver 354, the channel processor 394, the receive frame processor 360, the receive processor 370, and the controller/processor 390, memory 392 and linear interference cancellation module 393 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for cancellation of interference at a first user equipment, the method comprising:
performing channel estimation for each component of an aggregate received signal received from at least one Node B using at least one received midamble of at least one time slot;
computing a combined channel for each channelization code based on the channel estimation;
obtaining a linear transfer function for all user equipment within a cell, the linear transfer function comprising the combined channel for each channelization code;
deriving an equalization matrix from the linear transfer function; and
applying the equalization matrix to the aggregate received signal to obtain the component intended for the first user equipment.

2. The method of claim 1 wherein the aggregate received signal includes at least one component intended for a second user equipment.

3. The method of claim 1 further comprising:
determining an equivalent channel of a channelization code based on the channel estimation, wherein the combined channel is further based on the equivalent channel.

4. The method of claim 1 wherein the linear transfer function includes a sliding window, wherein each received component over two symbol periods originates from a transmitted signal in three symbol periods.

5. The method of claim 4 further comprising:
advancing the sliding window by one symbol period to derive a next received signal.

6. A first user equipment configured for interference cancellation, the user equipment comprising:
means for performing channel estimation for each component of an aggregate received signal received from at least one Node B using at least one received midamble of at least one time slot;
means for computing a combined channel for each channelization code based on the channel estimation;
means for obtaining a linear transfer function for all user equipment within a cell, the linear transfer function comprising the combined channel for each channelization code;
means for deriving an equalization matrix from the linear transfer function; and
means for applying the equalization matrix to the aggregate received signal to obtain the component intended for the first user equipment.

7. The user equipment of claim 6 wherein the aggregate received signal includes at least one component intended for a second user equipment.

8. The user equipment of claim 6 further comprising:
means for determining an equivalent channel of a channelization code based on the channel estimation, wherein the combined channel is further based on the equivalent channel.

9. The user equipment of claim 6 wherein the linear transfer function includes a sliding window, wherein each received component over two symbol periods originates from a transmitted signal in three symbol periods.

10. The user equipment of claim 9 further comprising:
means for advancing the sliding window by one symbol period to derive a next received signal.

11. A computer program product having a computer readable medium with non-transitory program code stored thereon, the program code comprising:
program code to perform channel estimation for each component of an aggregate received signal received from at least one Node B using at least one received midamble of at least one time slot;
program code to compute a combined channel for each channelization code based on the channel estimation;
program code to obtain a linear transfer function for all user equipment within a cell, the linear transfer function comprising the combined channel for the each channelization code;
program code to derive an equalization matrix from the linear transfer function; and
program code to apply the equalization matrix to the aggregate received signal to obtain the component intended for the first user equipment.

12. The computer program product of claim 11 wherein the aggregate received signal includes at least one component intended for a second user equipment.

13. The computer program product of claim 11 further comprising:
program code to determine an equivalent channel of a channelization code based on the channel estimation, wherein the combined channel is further based on the equivalent channel.

14. The computer program product of claim 11 wherein the linear transfer function includes a sliding window, wherein each received component over two symbol periods originates from a transmitted signal in three symbol periods.

15. The computer program product of claim 14 further comprising:
program code to advance the sliding window by one symbol period to derive a next received signal.

16. A first user equipment for wireless communication, comprising:
at least one processor; and
a memory coupled to the at least one processor,
wherein the at least one processor is configured:
to perform channel estimation for each component of an aggregate received signal received from at least one Node B using at least one received midamble of at least one time slot;
to compute a combined channel for each channelization code based on the channel estimation;
to obtain a linear transfer function for all user equipment within a cell, the linear transfer function comprising the combined channel for each channelization code;
to derive an equalization matrix from the linear transfer function; and
to apply the equalization matrix to the aggregate received signal to obtain the component intended for the first user equipment.

17. The user equipment of claim 16 wherein the aggregate received signal includes at least one component intended for other user equipment.

18. The user equipment of claim 16 wherein the at least one processor is further configured to determine an equivalent channel of a channelization code based on the channel estimation, wherein the combined channel is further based on the equivalent channel.

19. The user equipment of claim 16 wherein the linear transfer function includes a sliding window, wherein each received component over two symbol periods originates from a transmitted signal in three symbol periods.

20. The user equipment of claim 19 wherein the at least one processor is further configured to advance the sliding window by one symbol period to derive a next received signal.
